(19) United States
(12) Patent Application Publication
(10) Pub. No.: US 2026/0318768 A1
(43) Pub. Date: Oct. 15, 2026

(54) VEHICULAR TIRE AND WHEEL HEALTH MONITORING SYSTEM

(71) Applicant: Magna Electronics Inc., Auburn Hills, MI (US)

(72) Inventor: Joshua D. Kieleszewski, Oakland, MI (US)

(21) Appl. No.: 19/641,764

(22) Filed: Apr. 8, 2026

Related U.S. Application Data
(60) Provisional application No. 63/785,816, filed on Apr. 9, 2025.

(51) Int. Cl. G01M 1/28; B60C 23/04

(52) U.S. Cl. CPC G01M 1/28; B60C 23/0488

(57) ABSTRACT

A vehicular sensing system includes a sensor that senses movement of a portion of the vehicle and includes at least one accelerometer. The vehicular sensing system, via processing at an ECU of sensor data captured by the sensor, monitors each wheel of a plurality of wheels of the vehicle. The vehicular sensing system, based at least in part on detecting movement of the portion of the vehicle that is outside a threshold range of movement, determines at least one of an out-of-alignment condition for at least one wheel of the plurality of wheels or an out-of-balance condition for a respective tire of the at least one wheel. In response to determining the out-of-alignment condition or the out-of-balance condition, the vehicular sensing system outputs an alert indicative of the determined condition to a user of the vehicle.

### CROSS REFERENCE TO RELATED APPLICATION

The present application claims the filing benefits of U.S. provisional application Ser. No. 63/785,816, filed Apr. 9, 2025, which is hereby incorporated herein by reference in its entirety.

### TECHNICAL FIELD

The present invention relates generally to a vehicle sensing system for a vehicle and, more particularly, to a vehicle sensing system that utilizes one or more sensors at a vehicle.

### BACKGROUND

Vehicles with poor tire and wheel health may create dangerous driving conditions. For example, improper tire pressure is a leading cause of tire-related accidents and may cause premature tire tread wear. Further, tire balance and wheel alignment issues may lead to premature tire replacement due to irregular and more rapid tire wear. Poor tire conditions may result in reduced traction, increased braking distances, and ultimately collisions for the equipped vehicle.

### SUMMARY

A vehicular sensing system includes a sensor disposed at a vehicle equipped with the vehicular sensing system. The sensor senses movement of a portion of the vehicle, and the sensor is operable to capture sensor data and includes at least one accelerometer. The sensor includes an electronic control unit (ECU) and, the ECU includes electronic circuitry and associated software. The electronic circuitry of the ECU includes a data processor for processing sensor data captured by the sensor and transferred to the ECU. The vehicular sensing system, via processing at the ECU of sensor data captured by the sensor and transferred to the ECU, monitors each wheel of a plurality of wheels of the vehicle. The vehicular sensing system, based at least in part on detecting movement of the portion of the vehicle that is outside a threshold range of movement, determines at least one of an out-of-alignment condition for at least one wheel of the plurality of wheels or an out-of-balance condition for a respective tire of the at least one wheel. In response to determining the out-of-alignment condition or the out-of-balance condition, the vehicular sensing system outputs an alert indicative of the determined condition to a user of the vehicle.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle with a sensing system that incorporates sensors; and

FIG. 2 is a schematic view of the sensing system.

### DETAILED DESCRIPTION

Industry and government studies indicate that tire-related issues are a significant contributing factor to vehicle accidents and road fatalities. Furthermore, historical data suggests that a substantial portion of vehicle operators fail to maintain proper tire inflation, and a similarly large segment often neglects proper wheel balance and alignment maintenance tasks.

While improper tire pressure is a common cause of premature tire wear and related driving issues, it is not the only cause. Unbalanced tires and misaligned wheels frequently lead to premature tire replacement due to irregular and accelerated wear. Detecting these issues conventionally relies on manual human perception; for example, an operator typically relies on feeling wheel vibrations to determine that a wheel is out of balance, a symptom that is often ignored or goes unnoticed. Similarly, monitoring uneven tread wear generally requires manual visual inspection, a task operators frequently neglect to perform.

An unbalanced or misaligned wheel can drastically reduce the operational lifespan of a tire, often causing operators to purchase multiple additional sets of tires over the lifespan of the vehicle. This accelerated degradation results in substantial financial expenditures, encompassing both the cost of the replacement tires and the associated installation labor. Over the lifespan of a vehicle, these avoidable tire-related costs can represent a significant percentage of the overall vehicle value. Further, prolonged balance and alignment issues may lead to secondary structural damage to wheels, wheel bearings, control arms, and other vehicular components. Moreover, uncorrected tire balance and wheel alignment issues negatively affect vehicle aerodynamics and rolling resistance, leading to a measurable decrease in overall fuel efficiency.

By mitigating these issues through proper and timely detection of tire balance and wheel alignment conditions, a vehicle owner can realize significant cost savings related to tire replacement, maintenance labor, and fuel consumption. In addition to economic advantages, mitigating premature tire replacement addresses global environmental and waste management concerns. Promptly identifying and correcting tire balance and wheel alignment issues substantially reduces the overall volume of discarded tires, thereby mitigating environmental impacts associated with tire waste.

Beyond the reduction of physical tire waste, mitigating excessive tire wear addresses related environmental concerns. For example, accelerated tire degradation generates particulate matter pollution. In some operational states, the particulate matter generated by excessive tire wear can present a significant environmental concern separate from standard exhaust emissions. By proactively detecting alignment and balance issues to ensure even and normal tire wear, the generation and release of such micro-particulate matter can be meaningfully reduced.

A vehicle sensing system and/or vehicle health monitoring system and/or driver alert system operates to capture sensor data indicative of vehicle dynamics and/or vehicle operating conditions. The system may process the captured sensor data to, for example, determine a health condition of one or more vehicle components, such as to detect tire balance issues, wheel alignment issues, and/or powertrain abnormalities. The sensing system includes a data processor or data processing system that is operable to receive sensor data from one or more sensors disposed at the vehicle (such as, for example, one or more accelerometers, tire pressure sensors, and/or steering sensors) and output a signal based on the processed sensor data. Optionally, the system is operable to provide an output to an alert device, mobile device, or display device for notifying a driver of the vehicle of a detected maintenance issue or component health condition.

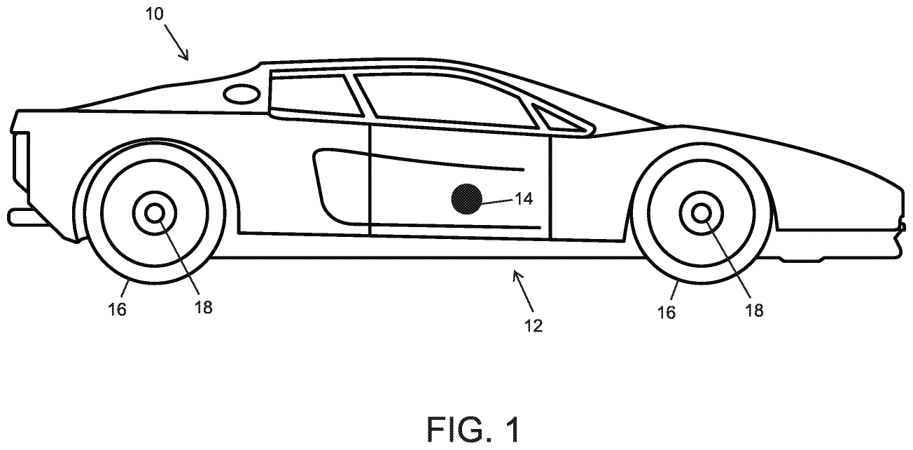

Referring now to the drawings and the illustrative embodiments depicted therein, a vehicle 10 (e.g., a passenger car, a light truck, or a commercial or heavy-duty vehicle) includes a vehicular sensing system 12. The vehicular sensing system 12 includes at least one sensor 14 disposed at the vehicle 10 to sense vehicle dynamics (e.g., vehicle speed, vehicle motion and position relative to a ground surface, such as pitch, roll, yaw, vehicle vibration, and the like). The vehicular sensing system 12 processes sensor data captured by the sensor 14 to determine a condition of one or more wheels 16 of the vehicle 10 (FIG. 1). For example, the sensor 14 may include an accelerometer. Further, each wheel 16 may include or be associated with an air pressure sensor 18. The air pressure sensor 18 may be part of a tire pressure monitoring system of the vehicle 10 that detects an air pressure of a tire at a corresponding wheel 16. The vehicular sensing system 12 includes an electronic control unit 20 having electronic circuitry and associated software. The electronic circuitry includes a data processor operable to process the sensor data captured by the sensor 14. The vehicular sensing system 12, via processing at the electronic control unit 20 of the sensor data captured by the sensor 14 and/or the air pressure sensor 18, may determine a health condition of one or more wheels 16 and/or corresponding one or more tires. The health condition may include a status of tire balance, wheel alignment, and/or tire tread wear. In some examples, the electronic control unit 20 determines the tire tread wear by detecting a shift in a resonant frequency of a tire structure over time as a tread mass decreases. Optionally, the electronic control unit 20 calculates the tire tread wear indirectly by integrating vehicle mileage data, historical wheel alignment data, and historical tire pressure data to estimate a rate of tread degradation. A data transfer or a signal communication from the sensor 14 and the air pressure sensor 18 to the electronic control unit 20 may comprise a vehicle network bus or the like of the vehicle 10.

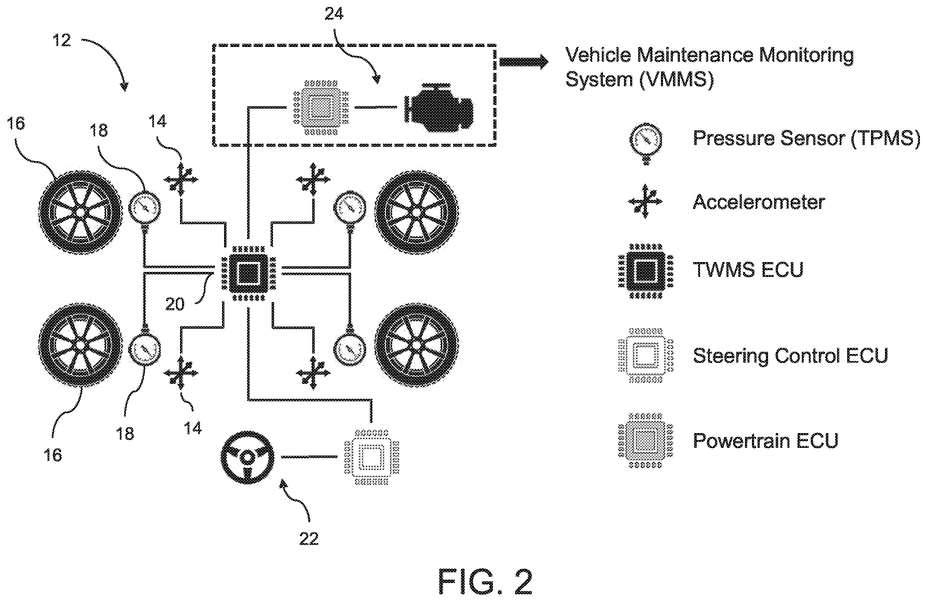

In the illustrated example of FIG. 2, the sensing system 12 includes a plurality of accelerometers 14, with each accelerometer 14 disposed at or near a respective wheel 16 of the vehicle 10. The accelerometers 14 may be disposed at the wheel 16 (such as integrated with the air pressure sensor 18) or at the vehicle chassis near the wheel 16. Each accelerometer 14 captures sensor data representative of dynamics of the wheel 16 and/or dynamics of a portion of the vehicle 10 at or near the wheel 16. The electronic control unit 20 processes the captured sensor data to isolate vibration characteristics associated with rotation of the wheel 16. In some examples, the electronic control unit 20 applies a Fast Fourier Transform algorithm to convert raw time-domain acceleration data received from the accelerometer 14 into frequency-domain data. The sensing system 12 may receive a vehicle speed signal from a vehicle speed sensor 26. Based on the vehicle speed signal and a predetermined outer diameter parameter of the wheel 16, the electronic control unit 20 calculates a first-order rotational frequency of the wheel 16. The electronic control unit 20 applies a bandpass filter to the frequency-domain data to isolate vibration amplitudes occurring at the calculated first-order rotational frequency. By detecting movement of the wheel 16 or movement of the portion of the vehicle 10 exhibiting a vibration amplitude at the first-order rotational frequency greater than a threshold level, the sensing system 12 may determine an out-of-balance condition of the wheel 16.

In some implementations, the sensing system 12 determines the out-of-balance condition of one or more wheels 16 based on signals from a single three-axis accelerometer 14 disposed at a central region of the vehicle chassis. The single three-axis accelerometer 14 captures multi-directional acceleration data, including longitudinal acceleration data along an X-axis, lateral acceleration data along a Y-axis, and vertical acceleration data along a Z-axis. The electronic control unit 20 evaluates a phase relationship among the longitudinal acceleration data, the lateral acceleration data, and the vertical acceleration data to identify a source location of detected vibrations. The electronic control unit 20 utilizes predetermined transfer functions representing structural transmission characteristics of a suspension system of the vehicle 10. A vibration originating at a front-left wheel 16 generates a distinct combination of pitch and roll dynamics compared to a vibration originating at a rear-right wheel 16. By cross-referencing the multi-directional acceleration data with the predetermined transfer functions, the electronic control unit 20 triangulates the out-of-balance condition to a specific wheel 16 of the vehicle 10 using the single three-axis accelerometer 14.

Wheel alignment issues may also be detected based on sensor data captured by the accelerometers 14. For example, misalignment of the wheels may cause vibration, pulling of the vehicle to one side, uneven tire wear, and the like.

Moreover, the vehicular sensing system 12 may determine wheel alignment issues based on signals received from a steering system 22 of the vehicle 10. For example, the steering system 22 may transmit signals to the vehicular sensing system 12 representative of a steering wheel angle during operation of the vehicle 10. The vehicular sensing system 12 may determine wheel alignment issues based on changes in steering wheel angle patterns while driving straight or turning. In some implementations, the vehicular sensing system 12 receives a steering angle signal from a steering angle sensor 30 and a vehicle yaw signal from a yaw rate sensor 32. The electronic control unit 20 compares the steering angle signal against the vehicle yaw signal. In response to the vehicle yaw signal indicating the vehicle 10 is traveling in a straight path with a substantially zero yaw rate while the steering angle signal indicates a non-zero steering wheel angle offset for a sustained period, the electronic control unit 20 flags an alignment issue, such as a thrust angle misalignment or a toe misalignment. Additionally or alternatively, the vehicular sensing system 12 receives a torque signal from a steering torque sensor 34 of the steering system 22. The electronic control unit 20 monitors a torque applied to a steering wheel to maintain a straight vehicle path. A consistent application of torque to maintain the straight vehicle path indicates the vehicle 10 is pulling to one side, thereby causing the electronic control unit 20 to detect a wheel alignment issue. Further, the steering angle sensor 30 may indicate vibration in the steering wheel caused by wheel alignment issues.

In response to determining tire balance or wheel alignment issues, the system 12 may generate an alert to the driver of the vehicle 10. For example, the system 12 may illuminate an icon at a gauge cluster of the vehicle 10, display a warning or alert message at a display screen of the vehicle (e.g., at an infotainment screen of the vehicle), generate an audio or haptic alert within the cabin of the vehicle, and the like. In some examples, the system 12 may wirelessly transmit the alert to a mobile device associated with the driver, such as via a mobile phone application associated with the vehicle 10. The alert may indicate which wheel 16 is demonstrating the issue and whether the issue is related to tire balance, wheel alignment, or air pressure.

Optionally, the sensing system 12 may receive signals from additional sensors and systems of the vehicle to monitor for changes in operation and potential vehicle maintenance needs. For example, the sensing system 12 may receive signals from a powertrain system 24 of the vehicle 10. Increased vibrations detected at the powertrain system 24, such as tied to the engine speed or cam speed, may indicate a powertrain issue that requires maintenance. This may result in issue detection prior to a component failure that causes a check engine light to illuminate.

Wheel balance issue detection may be achieved using accelerometers 14. The accelerometers 14 may be integrated with the air pressure sensors 18 in the wheel 16 or added to the vehicle chassis. The sensing system 12 accesses a memory 28 storing expected vibration levels for balanced wheels and unbalanced wheels. The electronic control unit 20 sets thresholds based on the expected vibration levels to detect balance issues and trigger an alarm to the driver of the vehicle 10. The expected vibration levels may be generated based on data collected on test vehicles operating with wheels having predetermined balanced conditions, predetermined unbalanced conditions, predetermined aligned conditions, and predetermined misaligned conditions. In some examples, the electronic control unit 20 utilizes a machine learning model to classify a health condition of the wheel 16. The machine learning model may include a support vector machine or an artificial neural network trained using an empirical dataset comprising historical acceleration data, historical steering angle data, and corresponding labeled wheel health states. The electronic control unit 20 inputs the captured sensor data into the machine learning model and receives a classification output indicating a predicted presence of an unbalanced wheel condition or a misaligned wheel condition. As discussed herein, determining a specific wheel 16 experiencing the balance issue or the alignment issue may be accomplished using the single three-axis accelerometer 14 mounted at a chassis center point. Optionally, an individual sensor 14 may be mounted at each wheel 16 to determine the specific wheel 16 experiencing the balance issue or the alignment issue.

The vehicle sensing system may utilize characteristics of the tire monitoring systems described in U.S. Pat. Nos. 7,423,522; 7,053,761; 6,774,774 and/or 6,731,205 and/or U.S. Publication No. US-20203-0364948, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system, wherein the sensor senses movement of a portion of the vehicle, and wherein the sensor is operable to capture sensor data, and wherein the sensor comprises at least one accelerometer;
an electronic control unit (ECU);
wherein the ECU comprises electronic circuitry and associated software;
wherein the electronic circuitry of the ECU comprises a data processor for processing sensor data captured by the sensor and transferred to the ECU;
wherein the vehicular sensing system, via processing at the ECU of sensor data captured by the sensor and transferred to the ECU, monitors each wheel of a plurality of wheels of the vehicle; and
wherein the vehicular sensing system, based at least in part on detecting movement of the portion of the vehicle that is outside a threshold range of movement, determines at least one of an out-of-alignment condition for at least one wheel of the plurality of wheels or an out-of-balance condition for a respective tire of the at least one wheel; and
wherein, in response to determining the out-of-alignment condition or the out-of-balance condition, the vehicular sensing system outputs an alert indicative of the determined condition to a user of the vehicle.

2. The vehicular sensing system of claim 1, wherein the sensor is disposed at a central region of a chassis of the vehicle.

3. The vehicular sensing system of claim 1, wherein the vehicular sensing system comprises a plurality of sensors disposed at the vehicle, and wherein each sensor of the plurality of sensors senses movement of a respective portion of the vehicle that corresponds to a wheel of the plurality of wheels.

4. The vehicular sensing system of claim 3, wherein at least one sensor of the plurality of sensors is respectively disposed at each wheel of the plurality of wheels.

5. The vehicular sensing system of claim 4, wherein each at least one sensor of the plurality of sensors is integrated with a respective at least one air pressure sensor of a tire pressure monitoring system (TPMS) of the vehicle.

6. The vehicular sensing system of claim 1, wherein the vehicular sensing system detects vibration of the portion of the vehicle, and wherein the threshold range of movement comprises a maximum amplitude of vibration of the portion of the vehicle.

7. The vehicular sensing system of claim 1, wherein the vehicular sensing system detects vibration of the portion of the vehicle, and wherein the threshold range of movement comprises (i) a minimum frequency of vibration of the portion of the vehicle and (ii) a maximum frequency of vibration of the portion of the vehicle.

8. The vehicular sensing system of claim 1, wherein the vehicular sensing system monitors each wheel of the plurality of wheels of the vehicle further based on signals received from a steering wheel position sensor of the vehicle.

9. The vehicular sensing system of claim 8, wherein the vehicular sensing system, based at least in part on determining vibration at the steering wheel position sensor of the vehicle, determines the out-of-alignment condition for the at least one wheel of the plurality of wheels.

10. The vehicular sensing system of claim 8, wherein the vehicular sensing system determines the out-of-alignment condition based on detecting a change in a vibration pattern at the steering wheel position sensor while the vehicle is driving straight compared to while the vehicle is turning.

11. The vehicular sensing system of claim 1, wherein the threshold range of movement is based on a baseline mapping of expected vibration levels associated with a known balanced tire condition.

12. The vehicular sensing system of claim 1, wherein the ECU further receives signals from a powertrain system of the vehicle indicative of at least one of an engine speed or a cam speed, and wherein the vehicular sensing system detects a potential powertrain issue by correlating a detected vibration with an order of the engine speed or the cam speed.

13. A method for monitoring a vehicle, the method comprising:
capturing, by a sensor disposed at the vehicle, sensor data indicative of movement of a portion of the vehicle, wherein the sensor comprises at least one accelerometer;
processing, by a data processor of an electronic control unit (ECU), the captured sensor data to monitor each wheel of a plurality of wheels of the vehicle;
determining, by the ECU, based at least in part on detecting movement of the portion of the vehicle that is outside a threshold range of movement, at least one of an out-of-alignment condition for at least one wheel of the plurality of wheels or an out-of-balance condition for a respective tire of the at least one wheel; and
outputting, in response to determining the out-of-alignment condition or the out-of-balance condition, an alert indicative of the determined condition to a user of the vehicle.

14. The method of claim 13, wherein the sensor is disposed at a central region of a chassis of the vehicle.

15. The method of claim 13, wherein capturing the sensor data comprises capturing sensor data from a plurality of sensors disposed at the vehicle, and wherein the method further comprises sensing, via each sensor of the plurality of sensors, movement of a respective portion of the vehicle that corresponds to a wheel of the plurality of wheels.

16. The method of claim 15, wherein at least one sensor of the plurality of sensors is respectively disposed at each wheel of the plurality of wheels.

17. The method of claim 16, wherein each at least one sensor of the plurality of sensors is integrated with a respective air pressure sensor of a tire pressure monitoring system (TPMS) of the vehicle.

18. The method of claim 13, wherein detecting movement of the portion of the vehicle comprises detecting vibration of the portion of the vehicle, and wherein the threshold range of movement comprises a maximum amplitude of vibration of the portion of the vehicle.

19. The method of claim 13, wherein detecting movement of the portion of the vehicle comprises detecting vibration of the portion of the vehicle, and wherein the threshold range of movement comprises (i) a minimum frequency of vibration of the portion of the vehicle and (ii) a maximum frequency of vibration of the portion of the vehicle.

20. The method of claim 13, wherein monitoring each wheel of the plurality of wheels of the vehicle is further based on signals received by the ECU from a steering wheel position sensor of the vehicle.
